(19) United States
(12) Patent Application Publication
(10) Pub. No.: US 2020/0387849 A1
(43) Pub. Date: Dec. 10, 2020

(54) MODULAR MACHINE-LEARNING BASED MARKET MIX MODELING

(71) Applicant: ACCENTURE GLOBAL SOLUTIONS LIMITED, Dublin 4 (IE)

(72) Inventors: Derek P. LEVESQUE, Trumbull, CT (US); Sanjay SHARMA, New Delhi (IN); Rupesh KUMAR, Atlanta, GA (US); Keshav RASTOGI, Gurgaon (IN); Kanika JAIN, New Delhi (IN); Rahul SHARMA, Delhi (IN)

(73) Assignee: ACCENTURE GLOBAL SOLUTIONS LIMITED, Dublin 4 (IE)

(21) Appl. No.: 16/436,466

(22) Filed: Jun. 10, 2019

(51) Int. Cl. G06Q 10/06; G06N 20/20

(52) U.S. Cl. CPC G06Q 10/06393; G06N 20/20

(57) ABSTRACT

A system provides a configurable market mix modeling (MMM) platform based on machine-learning (ML). The system may include configurable MMM pipelines in which an end user may identify portions and/or inputs to the MMM pipelines to be included or excluded from ML modeling. The system may apply ML to market data to automatically discover variables that correlate with a key performance indicator (PKI) such as sales to be used for modeling. The system may automatically generate multiple models, filter the models for robustness and ensemble the filtered models to generate a unified model. The unified model may be optimized using a multi-layered approach and introducing deviations into the model.

### TECHNICAL FIELD

This patent application relates generally to automating development of machine-learning (ML) models and more particularly to applying customizable ML to market data for automatically generating market mix models, and ensembling and optimizing the models.

### BACKGROUND

Market mix models (MMMs) may assess the impact of various events such as marketing activity on a key performance indicator such as sales. These MMMs may be developed by a model developer in a technical and “black box” manner from the point of view of an end user. Thus, the end user usually cannot run iterations or customize the models due to the oftentimes highly complex technical nature of model development and setup.

MMM development may involve a variable selection process that may be controlled by the model developer. In an attempt to create a model with high accuracy, the model developer may add too many variables to capture maximum variation in sales. This process may lead to a dimensionality problem, which results in poor performance of machine-learning (ML) algorithms used to build the model and poor performance of the model itself. Another problem with MMM development is a problem of overfitting in which a given model may perform well on training data but is not able to generate predictions at the same level of accuracy on new (future) data. Thus, these models may explain past behavior well but may fail to model new data with the same level of accuracy. These and other problems with ML-based market mix modeling can make such modeling difficult and inaccurate.

### BRIEF DESCRIPTION OF THE DRAWINGS

Features of the present disclosure may be illustrated by way of example and not limited in the following figure(s), in which like numerals indicate like elements, in which:

FIG. 1 illustrates an architecture of a computer system for machine-learning (ML) based market mix modeling (MMM);

FIG. 2 illustrates an example of a market mix modeling pipeline;

FIGS. 3A and 3B together illustrate an example dataflow for market mix modeling based on machine-learning;

FIG. 4A illustrates an example of a modular and configurable market mix modeling pipeline;

FIG. 4B illustrates another example of a modular and configurable market mix modeling pipeline;

FIG. 4C illustrates another example of a modular and configurable market mix modeling pipeline;

FIG. 4D illustrates another example of a modular and configurable market mix modeling pipeline;

FIG. 5 illustrates an example schematic diagram of model building based on automated variable selection and retention, saturation, and lag input;

FIG. 6 illustrates an example schematic diagram of automated model building and validation; and

FIG. 7 illustrates an example method of generating market mix modeling based on machine-learning.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

As previously noted, MMM may suffer from being a static, black box offering, with restrictive assumptions required to apply their results. The disclosure relates to a flexible (end user configurable), industry-agnostic, and unrestricted MMM development pipeline that addresses dimensionality and overfitting problems.

An MMM subsystem described herein may include a “plug and play” design that allows a user to select an ML technique and pick and choose various functionality to be included in or excluded from MMM development through a control interface. Thus, the MMM subsystem may enable non-technical end users to control and design MMM pipelines for model development. The MMM subsystem may account for media channel interactions and synergies in media and integrate industry knowledge to ensure robustness and reflect real-world outcomes.

In some examples, the MMM subsystem may remove modeler's bias by automating various aspects of the model building process. For example, the MMM subsystem may automatically discover variables that correlate with sales by applying ML to external data that includes marketing and sales data. Alternatively, or additionally, the MMM subsystem may identify variables to be used based on previous modeling. In either instance, the effects of manual variable selection on modeling may be reduced or eliminated.

The MMM subsystem may incorporate various data and analysis to further improve model performance. For example, the MMM subsystem may analyze complex cross-channel relationships and their impact on sales for modeling.

In some examples, the MMM subsystem may incorporate prior knowledge relating to response of media to sales so that this knowledge may be updated based on new data and subsequent training. Alternatively, or additionally, the MMM subsystem may incorporate knowledge relating to retention and saturation levels of media used for marketing. Such knowledge may be available through market research studies, previous modelling exercises or media execution experience. The MMM subsystem may leverage this prior knowledge to guide model development such that modeling takes into account the retention and saturation levels of media.

The MMM subsystem may facilitate automated model selection by evaluating media transformations and automatically selecting a given transformation to be used. In some examples, the MMM subsystem may do so by creating multiple models, filtering out under-performing models, and ensembling filtered models into a single unified model to reduce variance, increase model stability, and improve performance. Through ensembling, the MMM subsystem may also attain optimized retention and saturation effects of each media channel, which may further reduce modeler's bias.

The MMM subsystem may optimize the unified model with optimal media transformations as a starting point for arriving at a final model estimate. For example, the MMM subsystem may generate multiple layers of models by introducing deviations in estimates, using the unified model as a starting point. The MMM subsystem may use the last layer of the optimization process to determine final estimates and the final model.

In some examples, the MMM subsystem may remove or reduce model uncertainty. Some MMM development processes may introduce the problem of overfitting due to limited training. The MMM subsystem may assess performance of models that are either built automatically and/or through ensembling. Based on such assessments, the models may be retrained or retained/finalized. Such validation may address the problem of overfitting.

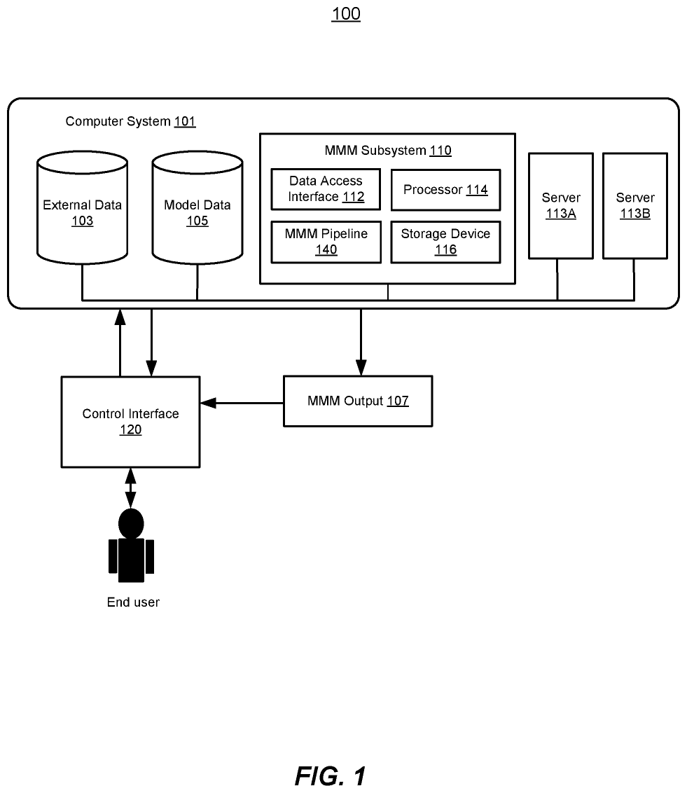

FIG. 1 illustrates an architecture 100 of a computer system 101 for machine-learning (ML)-based market mix modeling (MMM). The computer system 101 may automatically select various portions of an MMM pipeline to execute based on end user input, generate MMMs, filter the MMMs, ensemble the MMMs, optimize the MMMs, and/or perform other functions to automate robust models for market mix.

The computer system 101 may operate in a computer environment, such as a local computer network or a cloud-based computer network. The computer system 101 may include a variety of servers 113a and 113b that facilitate, coordinate, and manage information and data. For example, the servers 113a and 113b may include any number or combination of the following servers: exchange servers, content management server, application servers, database servers, directory servers, web servers, security servers, enterprise servers, and analytics servers. Other servers to provide a cyber range may also be provided.

It should be appreciated that a single server is shown for each of the servers 113a and 113b, and/or other servers within the systems, layers, and subsystems of the computer system 101. However, it should be appreciated that multiple servers may be used for each of these servers, and the servers may be connected via one or more networks. Also, middleware (not shown) may include in the computer system 101 as well. The middleware may include software hosted by one or more servers. Furthermore, it should be appreciated that some of the middleware or servers may or may not be needed to achieve functionality. Other types of servers, middleware, systems, platforms, and applications not shown may also be provided at the back-end to facilitate the features and functionalities of the computer system 101.

The external data 103 may include a datastore that may store ingested market data such as marketing data that includes sales and marketing activity. The external data 103 may be used to computationally train the MMMs. The model data 105 may include a datastore that may store information and data associated with the MMMs (including prior and current variables used in modeling). Other data stores may also be provided in the computer system 101, such as data marts, data vaults, data warehouses, data repositories, etc.

It should be appreciated that the data stores described herein may include volatile and/or nonvolatile data storage that may store data and software or firmware including machine-readable instructions. The software or firmware may include subroutines or applications that perform the functions of the computer system 101 and/or run one or more application that utilize data from the computer system 101. Other various server components or configurations may also be provided.

The MMM subsystem 110 may include various layers, processors, systems or subsystems. For example, the MMM subsystem 110 may include a data access interface 112, a processor 114, a storage device 116, a MMM pipeline 140. Other layers, processing components, systems or subsystems, or analytics components may also be provided.

There may be many examples of hardware that may be used for any of the servers, layers, subsystems, and components of the MMM subsystem 110. For example, the processor 114 may be an integrated circuit, and may execute software or firmware or comprise custom processing circuits, such as an application-specific integrated circuit (ASIC) or field-programmable gate array (FPGA). The data access interface 112 may include any number of hardware, network, or software interfaces that serves to facilitate communication and exchange of data between any number of or combination of equipment, protocol layers, or applications. For example, the data access interface 112 may include a network interface to communicate with other servers, devices, components or network elements via a network in the MMM subsystem 110. The components of the MMM subsystem 110 may provide respective functions. The data access interface 112 may provide a control interface 120. The control interface 120 may provide input options for an end user to identify portions of the MMM pipeline 140 to be used, provide inputs for modeling, view the MMM output 107, and/or otherwise interface with the computer system 101. The MMM output 107 may include a modeling result (output of a model), data from the external data 103 or model data 105, and/or other data accessible to the computer system 101.

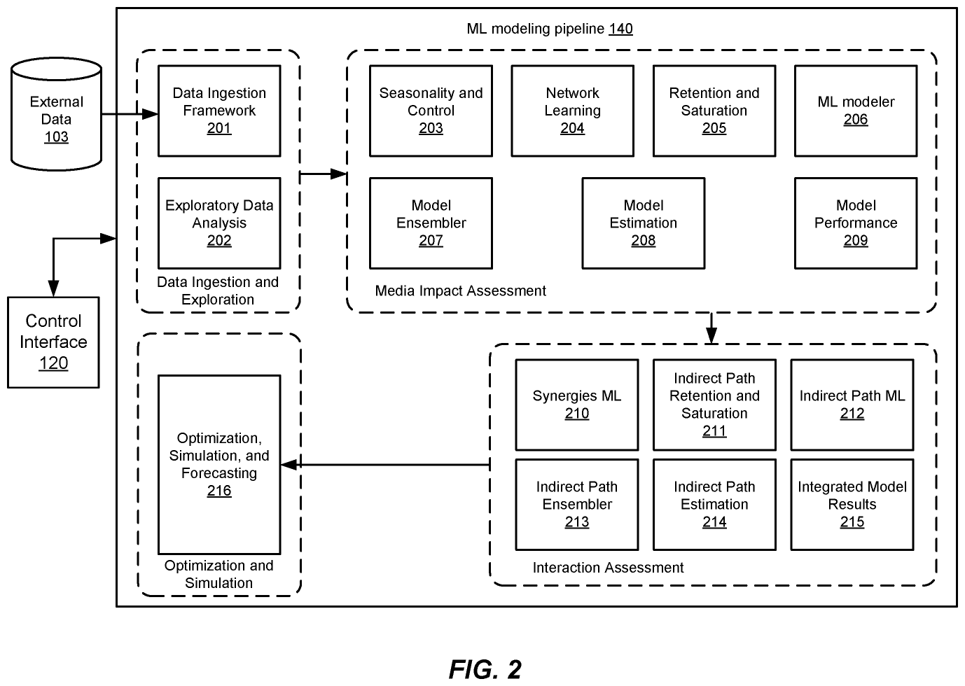

As will be discussed with respect to FIG. 2, the MMM pipeline 140 may include further sub-components, each of which may include instructions stored at the storage device 116 and executed by the processor 114. Alternatively, the sub-components of the MMM pipeline 140 may each include hardware configured to perform the functions of each sub-component. Further details of the MMM pipeline 140 and respective functions is also provided in FIG. 2.

FIG. 2 illustrates an example of a market mix modeling (MMM) pipeline 140. As used herein, the term “MMM pipeline” may refer to a set of functions that may be executed in an order (whether in series or parallel) to determine, based on ML, activities or events that are linked to or otherwise cause sales or other performance metric. Each of the portions of the MMM pipeline 140 may provide a respective function that an end user, such as a marketer, may select for inclusion therein. As such, a given MMM pipeline 140 may be a customizable set of functions, where at least some of the functions in the set of functions may be selected by an end user. For example, the control interface 120, which may be provided by the data access interface 112, may provide one or more user interfaces (such as a graphical user interface) for selecting various functions, or portions, to be included and executed in a MMM pipeline 140. The control interface 120 may further provide user interfaces for viewing data relating to the MMM pipeline 140, including ingested data, modeling results, and/or other MMM outputs 107.

In some examples, each of the selectable portions may be part of a functional group. A functional group may refer to an organization of functions to make it easier for an end user to select or operate the functions. Such functional groups may include data ingestion and exploration, media impact assessment, interaction assessment, and optimization and simulation. Other groups may be alternatively or additionally used as well. The data ingestion and exploration may be used to ingest external data 103 for data modeling and exploratory analysis. The media impact assessment may assess media impact via modeling, model ensembling, optimization, and assessment. The interaction assessment may assess interactions within different media channels via modeling, and model ensembling, optimization, and assessment. The optimization and simulation may optimize media activity (for example, to identify an optimum level of spend and/or activity of a media channels), run simulations, and forecast results of inputs such as spend or interaction channels, among other inputs.

Data ingestion and exploration may include a data ingestion framework 201 and an exploratory data analysis 202. Media impact assessment may include a seasonality and control 203, a network learning 204, a retention and saturation 205, an ML modeler 206, a model ensembler 207, a model estimation 208, and a model performance 209. The interaction assessment may include a synergies ML 210, an indirect path retention and saturation 211, an indirect path ML 212, an indirect path ensembler 213, an indirect path estimation 214, an integrated model results 215, an optimization, simulation and forecasting 216, and/or other functions. It should be noted that the data ingestion framework 201, the exploratory data analysis 202, the seasonality and control 203, the network learning 204, the retention and saturation 205, the ML modeler 206, the model ensembler 207, the model estimation 208, the model performance 209, the synergies ML 210, the indirect path retention and saturation 211, the indirect path ML 212, the indirect path ensembler 213, the indirect path estimation 214, the integrated model results 215, and the optimization, simulation and forecasting 216, may each include instructions executed by the processor 114 illustrated in FIG. 1.

The data ingestion framework 201 may handle data input for modeling and analysis. Such input may include incremental data that may be added periodically to be able to refresh (update) or otherwise re-train the models described herein. For example, the data ingestion framework 201 may automatically (without user intervention) integrate with diverse client taxonomies and data schemas.

In some examples, the data ingestion framework 201 may provide a normalized input schema for automated updates. The normalized input schema may include a comma-separated value format, an extensible markup language format, and/or other inputs schema that may normalize input from diverse data sources.

In some examples, an end user may initiate the data ingestion framework 201 by, for example, clicking on a “Run” button of the control interface 120. In connection with such data ingestion, the end user may provide end user input, such as via the control interface 112, which may include a spend input for specifying an amount of spend, a model setup for specifying a last refresh and current model location with analytical data set (ADS) (such as for refresh and/or obtaining prior predictor variables of previous modeling), a taxonomy update for specifying variable nomenclature, a transformation update to indicate ad stock, power and lag updates, and a predictor drop list for specifying variables to be dropped from modeling.

The exploratory data analysis (EDA) 202 may provide analysis of historical relationships between marketing spend and business performance. For example, the EDA 202 may provide a visual drag-and-drop authoring interface for such analysis. Using the visual drag-and-drop authoring interface, users may view data at user-specified levels of granularity for high quality data insights.

In some examples, the EDA 202 may provide an end-to-end overview of data modeled or otherwise processed by the MMM pipeline 140. For example, the EDA 202 may generate an interface to display data relating to sales, activity, and spend of an organization.

The seasonality and control 203 may determine seasonal events (such as a holiday period or other events such fall, winter, spring, and summer) that may impact sales without being explained by marketing efforts. In some examples, the seasonality and control 203 may apply ML techniques to automatically identify variables that specify the seasonal events and/or obtain an input from an organization (e.g., a user of the organization providing such input via the control interface 120). For example, the seasonality and control 203 may automatically analyze sales over time (a time series of data) to identify variables that indicate seasonal events.

To automatically identify such variables, the seasonality and control 203 may apply various techniques to a time series of data including sales or other performance metric. For example, the seasonality and control 203 may apply exponential smoothing, a fast Fourier transform (FFT), a Sigma rule, an unobserved component model (UCM), and/or other modeling techniques. For exponential smoothing, the seasonality and control 203 may break the time series into various components, such as a trend, seasonality, and random noise. For FFT, the seasonality and control 203 may try various frequency combinations to identify component frequencies of the time series and identify the frequency with the highest periodicity (or seasonality) to identify a seasonal event. For sigma rule, the seasonality and control 203 may identify parts of the time series that have large deviation from mean (such as beyond 1 standard deviation or other threshold deviation value). For UCM, the seasonality and control 203 may use Kalman filtering for estimation of unobserved components. Using UCM may identify parameters (such as trend, seasonality and baseline) that influenced sales or other performance metric that is unknown to exert such influence or is unable to be accurately tracked. In many instances, the effects of these unknown parameters may be misattributed to other factors such as media, promotion etc., skewing their effectiveness estimate.

By determining seasonal events and selecting appropriate variables for modeling based on domain knowledge from user input and/or automated ML learning, the seasonality and control 203 may enhance modeling efficiency by reducing run times that take into account such seasonal events.

The network learning 204 may conduct network learning to identify variables used for model training based on ML techniques and/or prior build predictor variables learned from previous models. For example, the network learning 204 may obtain an end user input (such as from the control interface 120) that specifies whether the variables are to be identified based on ML and/or the prior build predictor variables. The network learning 204 may access an end user input (such as from the control interface 120) that specifies whether the variables are to be identified based on ML and/or the prior build predictor variables to determine whether to identify variables based on ML and/or prior build predictor variables (variables from previous modeling). If ML based variable identification is selected by the end user, the end user may provide the following inputs that the network learning 204 may use for ML parameters.

The inputs provided by the end user may include, without limitation, a white list interaction indicating a list of predictor variables that should be used in the model, a black list interaction indicating a list of predictor variables that should not be used in the model, a consider bucket that indicates categories of variables such as media channel or control that will be considered for network creation (e.g., a “TV bucket” may include different television cuts like Local TV, National TV, Hispanic TV, etc.), a decay lower limit that specifies a lower limit of advertising (ad) stock, a decay upper limit specifying an upper limit of ad stock, a saturation lower limit specifying a lower limit of power, a saturation upper limit specifying an upper limit of saturation, a lag lower limit specifying a lower limit of lag, a lag upper limit specifying an upper limit of lag, and/or other inputs.

The retention and saturation 205 may determine potential model options based on various transformation ranges. The retention and saturation 205 may select the transformation ranges automatically based on ML techniques or based on domain expert knowledge from user input. For example, the retention and saturation 205 may execute the models based on the transformation of predictor variables to show the impact of such transformation on the model output.

In some examples, an end user may fix the transformation of variables that were finally selected by the network or were significant in a previous build (of models). For example, the end user may test and review the results of all transformed variables under a given model, which may be selectable by the end user.

The ML modeler 206 may model the impact of marketing efforts through various media on a key performance indicator (KPI) such as sales. Although examples of sales will be used throughout this disclosure for illustration, other KPI may be modeled, such as sentiment (e.g., positive or negative feelings about a marketed product, service, or person), to assess the impact of marketing efforts.

The ML modeler 206 may use various ML techniques, which may be selected by an end user via the control interface 120. For example, the different ML techniques may include, without limitation, gradient descent and linear regression techniques. Thus, the end user may opt to use gradient descent, linear regression, and/or other modeling techniques to build various models, which may be filtered and ensembled as will be described below. Additionally, or alternatively, the ML modeler 206 may train the models based on other end user inputs. For example, the ML modeler 206 may receive, via end user input at the control interface 120, various model configurations such as training data size, training and test data split size (by splitting the data into training and test data, bias and variance in modelling may be balanced), epochs (number of iterations), lower bound of initial variable estimate, upper bound of initial variable estimate, learning rate (for gradient descent), whether to ensemble models (for examples in which multiple models are generated),

By automating the model building process through automated discovery of variables (whether through ML or previous modeling), the ML modeler 206 may remove modeler's bias and improve precision.

The model ensembler 207 may automate model filtering to determine statistically stable and accurate models. A model with too many variables may have low precision, while a model with too few variables may be biased. The model ensembler 207 may ensemble models to obtain a balance between model bias (difference between the estimated value and true unknown value of a parameter) and variance (which is indicative the precision of the estimates) by building and analyzing multiple models. The model ensembler 207 may facilitate the generation and ensembling of multiple models simultaneously, facilitating the creation of more accurate and stable models. In some examples, the model ensembler 207 may ensemble models based on a generation phase, a pruning phase, and an integration phase.

During the generation phase, the model ensembler 207 may generate or access base models. For example, the model ensembler 207 may generate multiple sets of models, each model having the same or new variables, which may be introduced for the purpose of generating different models. The model ensembler 207 may apply the same diagnostics rule for each set of models.

During the pruning phase, the model ensembler 207 may filter models. For example, the model ensembler 207 may employ an Akaike information criterion (AIC) to estimate the relative quality of each model. The AIC may penalize the addition of parameters, and may therefore be used to select a model that fits well but has a minimum number of parameters (i.e., simplicity and parsimony). An example of an implementation of the AIC may be given by Equation (1):

AIC=−2ln(L(θ|x)+2K (1),

wherein:
K is the number of estimated parameters, and
L(θ|x) is maximum value of likelihood function.

In some examples, the model ensembler 207 may use AICc when the ratio of n(the sample size)/K (the number of estimated parameters) is less than a threshold value (such as approximately 40 or other threshold value) according to Equation (2):

$$AICc = - 2 ln ( θ \vert y ) + 2 K ( \frac{n}{n - K - 1} ) , \qquad ( 2 )$$

wherein:
K is the number of estimated parameters, and
N is the sample size.

The model ensembler 207 may use the differences in AICc (Δᵢ's) to interpret strength of evidence for one model compared to another model, according to Equation (3):

Δᵢ=AICcᵢ−AICcₘᵢₙ (3)

wherein:
AICcᵢ is the AICc value for model i, and
AlCcₘᵢₙ is the AICc value of the best model.

Δᵢ<2 may indicate substantial evidence that the model is accurate.

Δᵢ between 3 and 7 may indicate that the model has some but not substantial evidence that the model is accurate.

Δᵢ>10 may indicate that the model is not accurate.

In some examples, the model ensembler 207 may use Akaike weights (wᵢ) to measure the strength of evidence for each model. Each weight may represent the ratio of delta AICc(Δᵢ) values for each model relative to the set of candidate models according to Equation (4):

$${w}_{i} = \frac{exp ( - 0.5 {Δ}_{i} )}{{\sum }_{i = 1}^{N} ( exp ( - 0.5 {Δ}_{i} ) )} , \qquad ( 4 )$$

wherein:
N is the number of models, and
Δᵢ is difference in AIC of model i relative to the best model.

The sum of all weights wᵢ equals 1. As such, a given weight wᵢ may indicate the probability that the corresponding model is the best among the set of candidate models. The model ensembler 207 may compare the Akaike weight of the best model (the model having the highest corresponding Akaike weight) and the Akaike weight of competing models to determine to what extent the best model is better than other models by calculating evidence ratios, according to Equation 5:

$$Evidence Ratio = \frac{{w}_{i}}{{w}_{j}} , \qquad ( 5 )$$

wherein the Akaike weight (w₁) for model j is compared against the Akaike weight wᵢ for model i.

Estimates of relative importance of predictor variables can be made by summing the Akaike weights of variables across all the models where the variables occur, according to Equation (6):

w+(j)=Σ_{i for x}_{ⱼ}wᵢ (6),
wherein w+(j) is a sum of the Akaike weights of variables across all the models where the variables occur.

The model ensembler 207 may rank variables based on the sums determined using Equation (6). For example, the larger the sum of weights, the more important the corresponding variable.

In some examples, during the integration phase, the model ensembler 207 may use model averaging to incorporate model selection uncertainty. When many terms are selected into a model, the fit tends to inflate the estimates. Model averaging may reduce bias and increases precision. Model averaging tends to shrink the estimates on the weaker terms, yielding better predictions.

In some examples, to average models, the model ensembler 207 may determine a weight for the parameter estimates for each candidate model using their corresponding model weights. The model ensembler 207 may sum the determine weights. Parameter estimates may be averaged over all models according to Equation (7):

\hat{θ̅}ᵢ=Σᵢ₌₁^{R}wᵢ\hat{θ}ᵢ (7),

wherein:
R is set of candidate models,
wᵢ is weight of model I, and
\hat{θ}ᵢ is estimate(response) of model i.

The output of model ensembler 207 may include an ensembled model that generates an equation with optimal retention and saturation impacts based on the multiple models that were analyzed. Whether to perform ensembling and various filters for such ensembling may be user-specified via the control interface 120. For example, the model ensembler 207 may obtain, via end user input at the control interface 120, a percentage model ensemble filter, a Durbin Watson (DW) cutoff (for gradient descent models) filter, a p-value cutoff filter, and/or other ensembling filters for filtering models for ensembling.

The percentage model ensemble filter may specify a percentage of models to be used to build ensemble model. The DW cutoff filter may specify a threshold DW cutoff value such that only models whose DW is greater than the threshold DW cutoff value may be ensembled/considered. A p-value cutoff filter may specify a threshold p-value cutoff value such that only models whose p-value is less than the threshold p-value cutoff value (in which a null hypothesis may be considered rejected) may be ensembled/considered. The model ensembler 207 may generate a unified model from the models for the modeling time frame based on the filter parameters.

The model estimation 208 may generate model robustness checks on the unified model (when ensembling is used) and/or other models generated by the ML modeler 206. It should be noted that the robustness checks employed by the model estimation 208 may be employed by the ML modeler 206 to evaluate models as they are created by the ML modeler 206. In some examples, if the training data size is less than 100% of all of the available data, then the data has been split into training and test data. As such, the unified model and/or other model may be been generated based on the training data. The model estimation 208 may re-estimate the unified model and/or other model using all of the data available (both training and test data). Such re-estimation may use the ML modeler 206 and/or the model ensembler 207.

The model performance 209 may assess the results of a given model generated by the MMM pipeline 140. Such results may be provided for a given reporting time frame, and may provide visibility into a correlation between ad spends, promotions and a performance metric that gauges an impact of the ad spends or promotions. Such performance metric may include a measured Key Performance Indicator (KPI) such as overall sales, brand painting, base versus incremental media contribution, model-wise contributions of different media activity, year-over-year comparison chart (such as between two year-over-year quarterly comparisons), effectiveness for different media activity, and/or other result.

The synergies ML 210 may determine synergies between traditional media (such as print, radio, television, and the like) and digital media (such as electronic mail, web-based ads, and the like) to accurately attribute the impact of a consumer interaction that leads to a customer sale across all paid and owned media, whether traditional or digital. The synergies ML 210 may determine cross-media channel interaction effects to quantify total impact on sales or other performance metric through direct and indirect effects. For example, the synergies ML 210 may measure direct effects of search, online display, and television ads on sales. The synergies ML 210 may also measure indirect effects such as the effect of television ads on search, where search directly drives sales and television ads indirectly drives sales by causing searches that lead to sales. Put another way, the synergies ML 210 may identify and take into account media channels that indirectly contribute to sales by influencing other media channels that directly contribute to sales.

The synergies ML 210 may identify synergies through machine learning. For example, the synergies ML 210 may use Bayesian belief networks to identify and model synergies. To do so, the synergies ML 210 may identify and apply variable inputs, conduct structure learning (to learn the structure of the belief network), determine parameter estimates, update belief networks, and perform model robustness checks.

To identify and apply variable inputs, the synergies ML 210 may identify variable inputs to be fed into the models based on feature selection. Performance, marketing, and control data may be fed into the model. Seasonality, trend, and other data anomaly information may be controlled for. To conduct structure learning, the synergies ML 210 may learn the relationships between variables. The ML set priors based on whitelist and/or blacklist information. The synergies ML 210 may perform hill climbing structure learning, although other types of network learning may be used as well.

The parameter estimates may quantify the relationships using the learned network structure. To determine parameter estimates, the synergies ML 210 may estimate the parameters based on the network structure. Each node in the network structure may be represented in a parent-child relationship, and the synergies ML 210 may determine the estimates through a maximum likelihood estimation. Domain knowledge or new data may be used to fine-tune the learned parameter estimates. To update belief networks, the synergies ML 210 may obtain, from domain experts (e.g., human domain expert users), adjustments to the learned parameter estimates. Alternatively, or additionally, new data may be used to fine-tune the estimates by incorporating such data as variable inputs to update the estimates. To perform model robustness checks, the synergies ML 210 may calculate in-sample mean absolute percentage error (MAPE) and out-of-sample MAPE to gauge model fit and accuracy. MAPE may be a measure of prediction accuracy of each model. In some examples, the synergies ML 210 may use 10-fold cross-validation and Bayesian information to reduce overfitting.

The indirect path retention and saturation 211 may determine potential model options based on different transformation ranges to manage and understand complex cross-channel relationships. Similar to the retention and saturation 205 for media impact assessment, for example, the retention and saturation 211 may select the transformation ranges automatically based on ML techniques or based on domain expert knowledge from user input.

The indirect path ML 212 may use one or more ML techniques that may account for channel interactions and synergies in media, exogenous factors and industry knowledge that ensures final outcomes are robust and make business sense. In some examples, the indirect path ML 212 may generate an indirect path based on ML and/or previous modeling. An indirect path may be a path that includes an indirect variable and a direct variable that respectively indirectly and directly influence sales or other performance metric. A direct variable may include a media channel whose direct effect on sales may be measured. For example, a price (of a product or service), a TV ad, a display, a search, or print ad may each be direct variables of a sale. Some or all of the foregoing may also be an indirect variable in an indirect path. For example, a TV ad, a display, or a print ad may indirectly influence a sale by influencing a direct variable.

To illustrate, the indirect path ML 212 may determine that a TV ad for a product may indirectly influence sales by causing an increase in searches for the product. For example, the number of searches for the product may increase during and after the TV ad is aired. The searches may be directly correlated to sales of the product, such as being linked to a purchase through a call-to-action or other link to the sale. As such, the indirect path ML 212 may generate an indirect path that includes the TV ad (TV media channel) and search (search medial channel).

For indirect path generation based on ML, the indirect path ML 212 may configure ML training based on one or more user inputs for the modeling. Such user input for the modeling may include an indirect predictor, a belief input, a whitelist, a blacklist, a consider bucket, a decay lower limit, a decay upper limit, a saturation lower limit, a saturation upper limit, a lag lower limit, a lag upper limit, and/or other user-selectable model input configurations. The indirect predictor may include a model-wise variable, identified in a direct path, whose indirect path response will be created by the indirect path ML 212.

The belief Input may include a listing of buckets that may be tested to create an indirect path for a variable identified through direct path modeling. The blacklist may include a list of predictors that should not have indirect effect on sales through a corresponding predictor variable. The whitelist may include a list of predictors that should have indirect effect on sales through the corresponding predictor variable. Like direct path, transformation limits may be specified for individual variables. Based on the user-selectable model input configurations, the indirect path ML 212 may generate indirect paths for a given variable.

In some examples, the indirect path ML 212 may generate indirect paths based on previous modeling, such as model wise initial estimates from a previous model.

The indirect path ensembler 213 may ensemble indirect path models, similar to the manner in which the model ensembler 207. Average model prediction through ensembling may be more accurate than most individual models. The models may be combined to create a unified model over a modeling time frame, which may efficiently uncover direct, indirect, and/or latent relationships in the data.

The indirect path estimation 214 may operate to generate robustness checks on the unified indirect path models and perform model re-estimation, similar to the manner in which the model estimation 208 operates.

The integrated model results 215 may generate a comprehensive view of channel interactions, tease out direct and indirect effect of media on sales, and highlight media synergies and interactions. Model objects and associated results may be stored at a data mart, such as external data 103 illustrated in FIG. 1. A visualization layer of the integrated model results 215 may pull the results from the data mart and make the data available through an interface, such as the control interface 120. The interface may display interactive and dynamic views of the results of modeling to better inform market mix.

The optimization, simulation and forecasting 216 may optimize the models generated via the MMM pipeline 140 based on region (e.g., geographic location), channel (e.g., type of media channel whether digital media or traditional media), product, etc. For example, the optimization, simulation and forecasting 216 may automatically adjust model variables and determine the result of such model optimization to identify optimum variables (such as which media to use, when to market, spend, and/or other variables).

In some examples, the optimization, simulation and forecasting 216 may receive an end user input (such as via the control interface 120) that specifies one or more constraints, as well as provide results of various hypothetical scenarios. As such, the optimization, simulation and forecasting 216 may provide an ability to test various scenarios to determine their impact on sales or other KPI.

In some examples, the optimization, simulation and forecasting 216 may provide periodic forecast from the latest models generated by the MMM pipeline 140. In this sense, the optimization, simulation and forecasting 216 may provide updated forecasting and suggestions based on current data available to the system so that marketers and others may revise their marketing strategies accordingly.

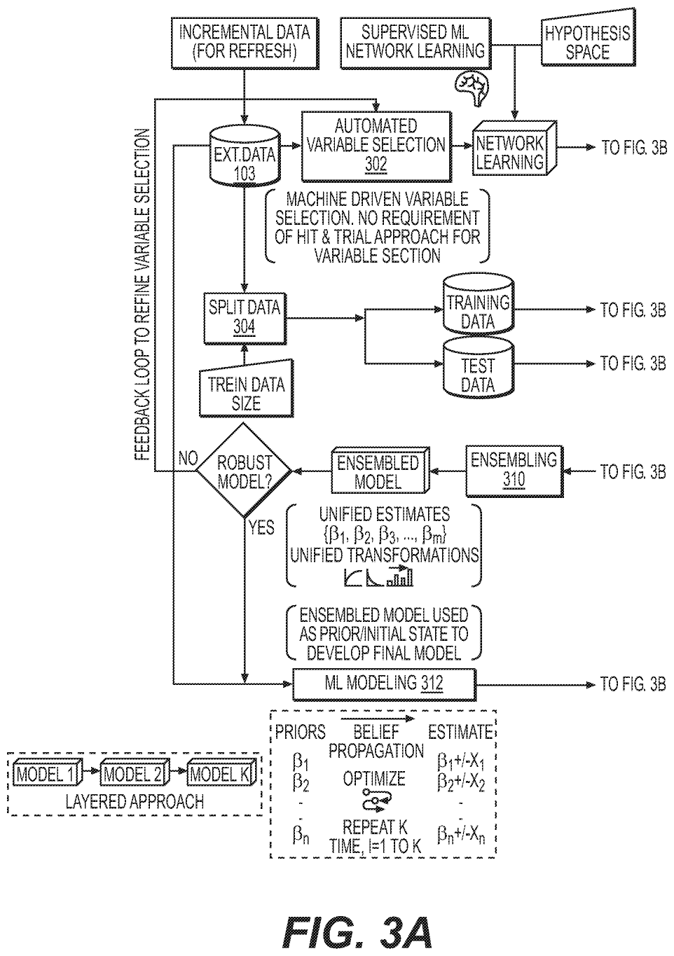

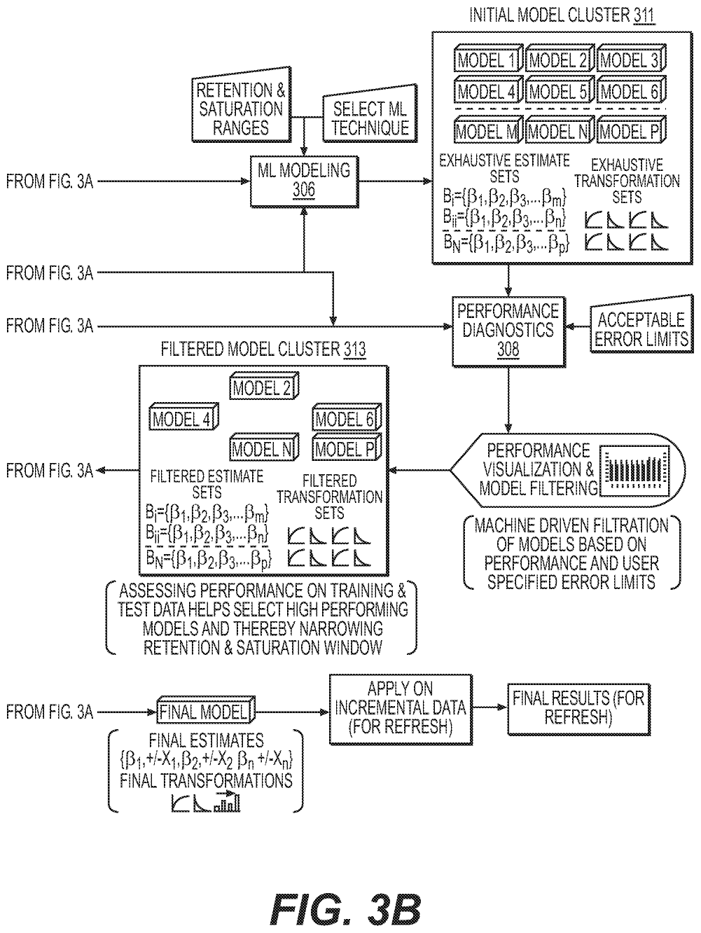

FIGS. 3A and 3B together illustrate an example dataflow for market mix modeling based on machine-learning. The dataflow illustrated in FIGS. 3A and 3B may be implemented by one or more elements illustrated in FIGS. 1 and 2. As such, various ones of the functional blocks 302-312 illustrated in FIGS. 3A and 3B may be implemented at one or more of the elements illustrated in FIGS. 1 and 2.

In some examples, external data 103 may be used for ML training to generate an initial set of models 1-6, M, N, P (initial model cluster 311).

At 302 (“Automated Variable Selection 302”), the MMM pipeline 140 may automatically select variables for modeling based on supervised ML network learning. Such supervised ML network learning may use a Bayesian belief network to identify variables that correlate with a performance metric such as sales. Examples of the variables include, without limitation, a brand health (whether the brand was tried by consumers or unaided awareness of the brand by consumers), TV (national, regional, etc.), trade scheme, total cinema, out of home, digital-video, content-print, sponsorships, consumer promotions (sampling, point of sale promotions), digital (social media, standard display, rich media, mobile), radio, and/or other variables that may have a direct, indirect, or latent impact on sales or other performance metric. The hypothesis space used for the supervised ML network learning may be input by an end user via the control interface 120 of the data access interface 112. In some examples, at block 302, the MMM pipeline 140 may alternatively or additionally identify the variables based on previously learned variables from prior modeling. For example, the MMM pipeline 140 may have been previously executed by an end user to generate a model, the variables for which may be re-used in the current execution of the ML modeling pipeline.

At 304 (“split data 304”), the MMM pipeline 140 may split some or all of the external data 103 to generate training data and test data. Such splitting may be based on a training data size input by an end user via the control interface 120.

At 306 (“ML modeling 306”), the MMM pipeline 140 may apply ML (such as gradient descent or linear regression) to the training data based on the automatically identified (learned) variables from block 302. In some examples, the ML modeling may take into account retention and saturation ranges and ML technique, either or both of which may be input by an end user via the control interface 120. The result of ML modeling may include an initial model cluster 311.

At 308 (“Performance Diagnostics 308”), the MMM pipeline 140 may assess performance of the models (hereinafter also referred to as “initial models”) in the initial model cluster 311. For example, the MMM pipeline 140 may assess performance of the initial models by applying them to the testing data and the training data. Such assessment may use one or more acceptable error limits of error values that assess an error level of each model. The error values may include, without limitation, a p-value (which may show the minimum significant critical region), an R-square value (which may measure the strength of the relationship between the independent and dependent factors), a MAPE (which may include a measure of accuracy of the method for constructing fitted time series values in statistics), DW statistics (which may detect the presence of autocorrelation), and/or other error limit values. The acceptable error limits may be input by an end user via the control interface 120. In some examples, the MMM pipeline 140 may use the performance diagnostics 308 to generate visualizations and facilitate machine-driven filtering of the initial model cluster 311 to filter the initial models based on the acceptable error limits (limits on error values) or otherwise filter the initial models that do not perform satisfactorily (based on comparison to the acceptable error limits or other model performance diagnostic). For example, the MMM pipeline 140 may provide one or more error values (e.g., the p-value, R square value, MAPE, DW statistics, and/or others) for presentation to a user such as a domain expert, who may perform filtering based on those values. Based on such filtering received from the user and/or automatically performed based on cutoff values for the error values, the MMM pipeline 140 may generate a filtered model cluster 313 having filtered models 2, 4, 6, N, P (“filtered models”).

At 310 (“Ensembling 310”), the MMM pipeline 140 may ensemble the filtered models to generate an ensembled model (also referred to interchangeably as “unified model”). The ensembled model may provide a set of united estimates and unified transformations based on the filtered models.

At 312 (“ML modeling 312”), the MMM pipeline 140 may determine whether the model is robust. If not, the MMM pipeline 140 may return to block 302, where variable selection may be refined to enhance the robustness of the ensembled model. If yes, the MMM pipeline 140 may use the ensembled model as a prior/initial state to develop a final model (also referred to interchangeably as a “finalized model”). In other words, the MMM pipeline 140 may use the ensembled model with optimal media transformations as a starting point for arriving at a final model estimate. The MMM pipeline 140 may create multiple layers of models by introducing small deviations in estimates as a part of an optimization process over K iterations (where K is some integer). The MMM pipeline 140 may use the last layer of the optimization process to generate the final estimates and final model.

In some examples, the final model may be applied to incremental data on data refresh to generate final results for the incremental data. For example, additional marketing-related data may be ingested for a current set of marketing data, activity, and sales results. The final model may be applied to the incremental data to provide the final results associated with the current (incremental) data.

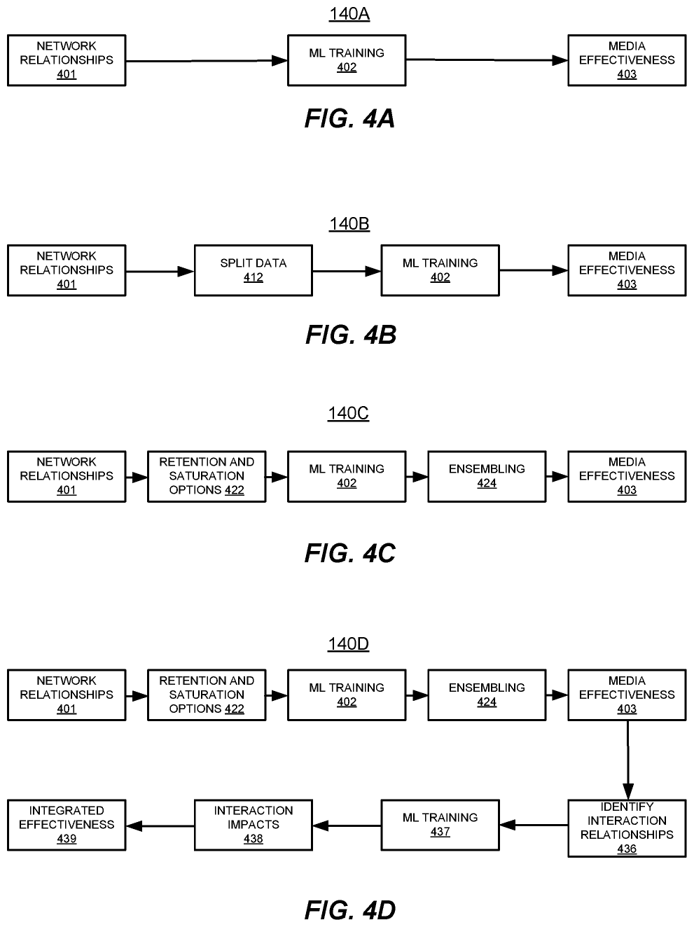

FIGS. 4A-D illustrate examples of configurable market mix modeling pipelines 140A-140D. The examples illustrated in FIGS. 4A-D are for illustrative purposes only. Based on the configurable nature of a given market mix modeling pipeline 140, the number and arrangement of the particular elements that form the given market mix modeling pipeline may be different than as illustrated. For example, an end user may configure, via the control interface 120, a market mix modeling pipeline according to market mix modeling pipelines 140A-140D or other configuration. It should be further noted that each of the market mix modeling pipelines 140A-140D are illustrated as having functional blocks, which may correspond to or be executed by elements illustrated in FIG. 1, 2 or 3.

FIG. 4A illustrates an example of a modular and configurable market mix modeling pipeline 140A. Market mix modeling pipeline 140A as illustrated may be configured as a relatively straightforward pipeline with automated network learning at the network relationships block 401, model training at ML training 402, and assessment of media effectiveness 403.

FIG. 4B illustrates another example of a modular and configurable market mix modeling pipeline 140B. As illustrated, market mix modeling pipeline 140B may include the elements of market mix modeling pipeline 140A but add validation of the models at split data 412, in which the applied model data is split into training data and test data for validation. For example, ML training 402 may be trained on the training data and may be validated using the test data.

FIG. 4C illustrates another example of a modular and configurable market mix modeling pipeline 140C. As illustrated, the market mix modeling pipeline 140C may be configured to include network relationships 401, but add retention and saturation options at block 422 that ML training 402 may use, and also add an ensembling 424 in which a plurality of models from the ML training are ensembled.

FIG. 4D illustrates another example of a modular and configurable market mix modeling pipeline 140D. As illustrated, the market mix modeling pipeline 140D may include the market mix modeling pipeline 140C, with added functionality. Such added functionality may include identification of interaction relationships 436 (identifying which interactions together lead to a sale, for example), ML training 437 based on the interaction relationships 436, assessment of interaction impacts 438, and an integrated effectiveness 439 that integrates media effectiveness and interaction relationships to predict factors that lead to a sale and/or other KPI.

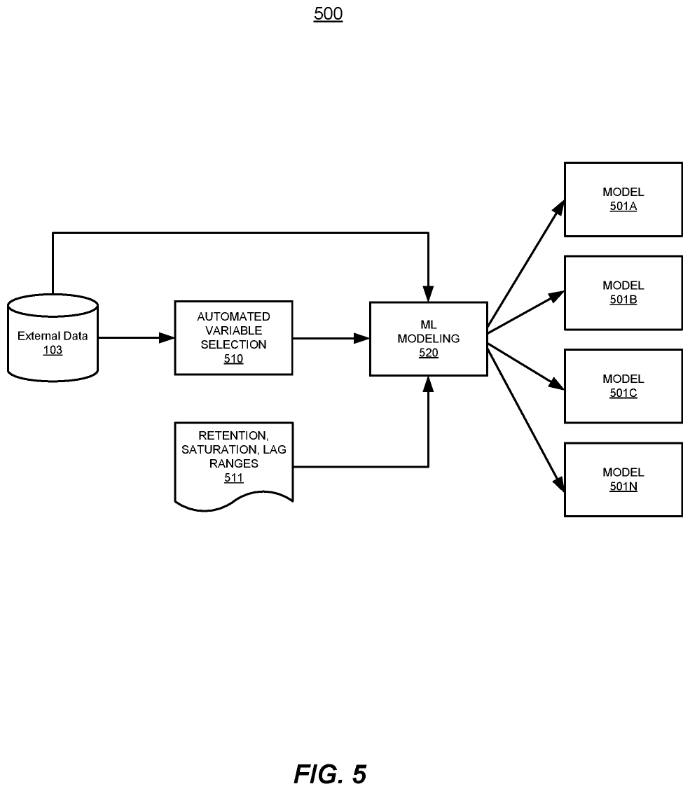

FIG. 5 illustrates an example schematic diagram 500 of model building based on automated variable selection and retention, saturation, and lag input. It should be noted that the various elements illustrated in FIG. 5 may be implemented in or by one or more elements illustrated in FIGS. 1-3.

End users often have at least some prior knowledge about retention and saturation levels of media channels used in marketing efforts. Retention may refer to an ability to retain customers through a given media channel. Saturation may refer to a point at which further marketing efforts on a given media channel will no longer be effective. This knowledge may be available either through market research studies, previous modelling exercises or through years of media execution experience.

The MMM subsystem 110 may take such prior knowledge as input during model development. For example, an end user may input the prior knowledge in form of a range of retention/saturation/lag levels via the control interface 120. Combining variables identified through automated selection process and business inputs for retention and saturation, the MMM subsystem 110 may generate a plurality of models. For example, at block 510, the MMM subsystem 110 may apply ML to external data 103 to identify variables for ML modeling at block 520. The retention, saturation, and lag ranges 511 may be input at block 520 to the MMM subsystem 110, which may generate a plurality of models 501A-501N. In some examples, the models 501 may be filtered, ensembled, assessed, and optimized to generate a final model.

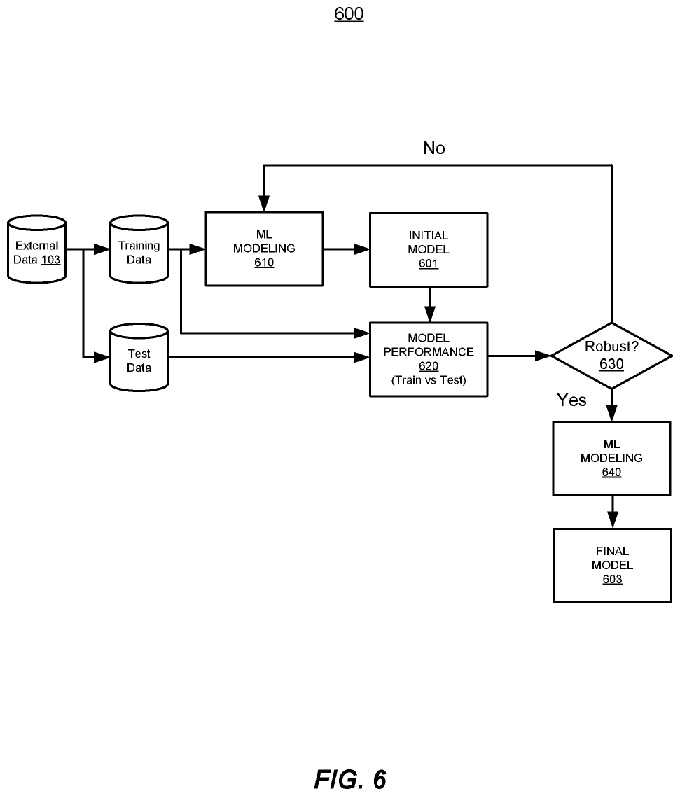

FIG. 6 illustrates an example schematic diagram 600 of automated model building and validation. It should be noted that the various elements illustrated in FIG. 6 may be implemented in or by one or more elements illustrated in FIGS. 1-3.

A classic approach to develop a market mix model is to build multiple options manually and select the one that has best performance. In addition, all available data, including recent/current (refresh) data, may be used to build the market mix model. Because of these behaviors, the final model for such a classic approach may suffer from the problem of overfitting. In other words, the final model may perform well on the training data but is not able to predict at the same level on new (future) data. Although the final model may explain past behavior, the final model may fail to make accurate predictions on future data.

The MMM subsystem 110 may validate models to assess performance of the models that are either built automatically and/or through ensembling to avoid or reduce the problem of overfitting.

For example, MMM subsystem 110 may split the external data 103 into training data and test data. At block 610, the MMM subsystem 110 may apply ML to the training data to generate an initial model 601. At block 620, the MMM subsystem 110 may assess model performance of the initial model 601 using the test data and compare results to the results of the training data. For example, the MMM subsystem 110 may determine a first error value, such as MAPE or other error value, for the initial model 601 using training data. Likewise, the MMM subsystem 110 may determine a second error value of the same type (such as MAPE) as the first error value for the initial model 601 using testing data. The MMM subsystem 110 may assess the performance of the initial model 601 by determine a difference between the first error value and the second error value. The MMM subsystem 110 may compare the difference to a threshold difference. For example, for MAPE, the threshold difference may be a maximum of ten percent. Lower differences may indicate less deviation between model results for training versus test data, showing higher model accuracy and ability to accurately predict results using new data.

At block 630, the MMM subsystem 110 may determine whether the initial model 601 is robust. If not, the MMM system 110 may return the initial model 601 back to ML modeling at block 610 to further refine the initial model. Such refinements may include selecting different variables or modifying existing variables used in the initial model 601. If the initial model 601 is determined to be robust, at block 640, the MMM subsystem 110 may perform further ML modeling to determine a final model 603. In this manner, an initial model may be validated based on a robustness check using test data (not just training data) to determine a final model 603.

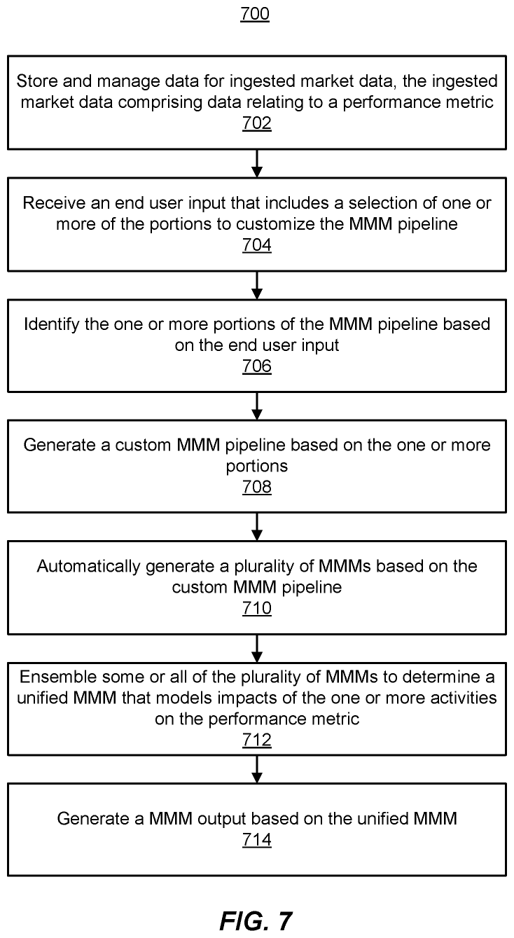

FIG. 7 illustrates an example method of 700 generating market mix modeling based on machine-learning. The method 700 is provided by way of example, as there may be a variety of ways to carry out the method described herein. Although the method 700 is primarily described as being performed by MMM subsystem 140 as shown in FIG. 1 or 2, the method 700 may be executed or otherwise performed by other systems, or a combination of systems. Each block shown in FIG. 7 may further represent one or more processes, methods, or subroutines, and one or more of the blocks may include machine-readable instructions stored on a non-transitory computer readable medium and executed by a processor, such as processor 114, or other type of processing circuit to perform one or more operations described herein.

At 702, one or more data stores 203 may store and manage data for data for ingested market data, the ingested market data comprising data relating to a performance metric such as sales or other PKI. For example, the ingested market data may include data relating to prior marketing activities such as amount of spend, time and duration of marketing (such as when and how long ads were run), seasonal effects, and/or other data relating to marketing activities. The ingested market data may further include sales or other performance metric data that may be correlated to the prior marketing activities and/or other data relating to marketing activities.

At 704, a data access interface 112 may expose selectable portions of a MMM pipeline and receive an end user input that includes a selection of one or more of the portions to customize the MMM pipeline 140. For example, the data access interface 112 may provide a control interface 120 that includes a user interface having input options for customizing the MMM pipeline 140. Such customizations may include selection of one or more functional groups of the MMM pipeline 140 to include (or exclude), variables used in the modeling as described herein, and/or other inputs.

At 706, the processor 114 may identify the one or more portions of the MMM pipeline based on the end user input. Such portions may include any one or more of the portions (in other words, functions) 201-216 illustrated in FIG. 2.

At 708, the processor 114 may generate a custom MMM pipeline 140 based on the one or more portions. For example, the custom MMM pipeline 140 may include the portions illustrated in FIGS. 4A-4D, although other customized set of functions may be included as well or instead. In this manner, the end user may design a set of functions (the custom MMM pipeline 140) for ML on marketing data to predict and optimize activities to maximize some performance metric such as sales.

At 710, the processor 114 may automatically generate a plurality of MMMs based on the custom MMM pipeline 140, the custom MMM pipeline using ML applied to the ingested market data, wherein each MMM of the plurality of MMMs models an impact of one or more activities on the performance metric. For example, the processor 114 may generate various MMMs that each model one or more variables (such as spend and/or other data relating to marketing activities) and their impact on a performance metric such as sales.

At 712, the processor 114 may ensemble some or all of the plurality of MMMs to determine a unified MMM that models impacts of the one or more activities on the performance metric.

At 714, the processor 114 may generate and provide, based on the unified MMM, an MMM output 107. The MMO output 107 may include a result of modeling, including predicted effects of certain activities on sales. For example, the unified MMM may output a hypothetical set of marketing activities such as spend amount, marketing time period, duration, and/or other activities and correlate such activities with predicted performance such as sales. In this way, the unified MMM may provide a set of activities and their predicted effect on sales.

It should be noted that the method 700 may be used to optimize marketing campaigns (which may be defined as a marketing activity that has a specified start date, termination date, duration, spend, and/or other parameter) in various ways.

For example, an end user may have a goal of maximizing sales (or other performance metric) and identifying an amount of spend that should be made to achieve maximum (or a certain amount) of sales. MMMs may be trained to provide such identification by correlating information specifying amounts of spend from prior marketing campaigns from the ingested market data with sales data from the ingested market data.

In another example, an end user may have a goal of maximizing sales (or other performance metric) given a predefined budget (maximum amount of spend) and identifying media channels to achieve such maximum sales in light of the budget. The MMMs may be trained to provide such identification by correlating information specifying amounts of spend of prior marketing campaigns from the ingested market data with sales data and media channel data from the ingested market data. For example, the MMMs may correlate media channels with sales, and then identify those channels that maximize sales per unit of spend. Other modeling and outcomes may be performed as well.

It should be appreciated that the data flows and methods described above are examples of scenarios provided by the computer system 101 of FIG. 1. Other examples or scenarios may also be contemplated. For instance, there may be a situation where functions and features of the computer system 101 may be employed via a cloud application. The cloud application may then facilitate the data security and protection analysis as described herein.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims and their equivalents.

1. A system of generating custom market mix models (MMMs) based on machine-learning (ML), comprising:
one or more data stores to store and manage data including ingested market data, the ingested market data comprising data relating to a performance metric;
one or more servers to facilitate operations using the data from the one or more data stores;
a MMM subsystem that communicates with the one or more servers and the one or more data stores, the MMM subsystem comprising:
a data access interface to expose selectable portions of a MMM pipeline, and receive an end user input that includes a selection of one or more of the portions to customize the MMM pipeline;
a processor to:
identify the one or more portions of the MMM pipeline based on the end user input;
generate a custom MMM pipeline based on the one or more portions;
automatically generate a plurality of MMMs based on the custom MMM pipeline, the custom MMM pipeline using ML applied to the ingested market data, wherein each MMM of the plurality of MMMs models an impact of one or more activities on the performance metric;
ensemble some or all of the plurality of MMMs to determine a unified MMM that models impacts of the one or more activities on the performance metric; and
generate a market mix output based on the unified MMM.

2. The system of claim 1, wherein to automatically generate the plurality of MMMs, the processor is further to:
apply ML to some or all of the ingested market data to automatically identify one or more variables that are correlated to the performance metric; and
select the one or more variables to be used in the plurality of MMMs.

3. The system of claim 2, wherein the one or more variables each relate to an event that is to be correlated to the performance metric based on the applied ML.

4. The system of claim 3, wherein the performance metric comprises a sale of a product or service.

5. The system of claim 4, wherein the one or more variables comprises a marketing activity or a media channel used to market the product or service.

6. The system of claim 2, wherein to automatically generate the plurality of MMMs, the processor is further to:
access retention and saturation impact information that specifies retention and saturation effects of a given media channel, wherein the plurality of MMMs take into account the retention and saturation impact information.

7. The system of claim 1, wherein to automatically generate the plurality of MMMs, the processor is further to:
select one or more previous variables previously identified from a prior ML application that automatically identified the one or more previous variables.

8. The system of claim 1, wherein the processor is further to:
filter the plurality of MMMs to generate a subset of the plurality of MMMs based on a quality metric of each MMM of the plurality of MMMs, wherein only the subset of the plurality of MMMs are ensembled to generate the unified MMM.

9. The system of claim 8, wherein the unified MMM averages results of the subset of the plurality of MMMs to reduce variance.

10. The system of claim 1, wherein the data access interface is further to expose an input option to specify a modeling technique to be used to generate the plurality of MMMs; and
wherein the processor is to receive the input option via the data access interface to specify the modeling technique and use the modeling technique to generate the plurality of MMMs.

11. The system of claim 1, wherein the processor is further to:
split the ingested market data into a training dataset and a test dataset;
generate an initial MMM based on the training dataset; and
assess a performance of the initial MMM to determine whether to retrain the initial MMM or finalize the initial MMM.

12. The system of claim 11, wherein the processor is further to:
determine that the performance of the initial MMM is unsatisfactory; and
retrain the initial MMM responsive to the determination that the performance of the initial MMM is unsatisfactory.

13. The system of claim 11, wherein the processor is further to:
determine that the performance of the initial MMM is satisfactory; and
finalize, based on the training dataset and the test dataset, the initial MMM responsive to the determination that the performance of the initial MMM is satisfactory.

14. The system of claim 1, wherein the ML modeling pipeline comprises: (i) a data ingestion and exploration to ingest and explore the market data, (ii) a media impact assessment to assess an impact of media on the performance metric, (iii) an interaction assessment to assess indirect path of interactions on the performance metric, and (iv) an optimization and simulation to optimize and simulate effects on the unified MMM, and wherein each of (i)-(iv) comprises a respective portion that is selectable for inclusion in the custom MMM pipeline.

15. The system of claim 14, wherein the processor is further to:
receive a selection of a respective portion of (ii), but not a respective portion of (iii) such that the impact of media is modeled but the impact of the indirect path of interactions on the performance metric is not modeled.

16. The system of claim 14, wherein the processor is further to:
receive a selection of a respective portion of (iii), but not a respective portion of (ii), and model, responsive to the selection, the impact of indirect path of interactions on the performance metric but not the impact of media.

17. The system of claim 14, wherein the processor is further to:
receive a selection of a respective portion of (ii) and (iii) and model, responsive to the selection, both the impact of indirect path of interactions and media on the performance metric.

18. A computer readable medium storing instructions for generating custom market mix models (MMMs) based on machine-learning (ML), the instructions when executed by a processor cause the processor to:
access one or more data stores to obtain data including ingested market data, the ingested market data comprising data relating to a performance metric;
automatically generate a plurality of MMMs based on the custom MMM pipeline, the custom MMM pipeline using ML applied to the ingested market data, wherein each MMM of the plurality of MMMs models an impact of one or more activities on the performance metric;
ensemble some or all of the plurality of MMMs to determine a unified MMM that models impacts of the one or more activities on the performance metric; and
generate a MMM output based on the unified MMM.

19. A method of generating custom market mix models (MMMs) based on machine-learning (ML), comprising:
receiving, by a processor, an end-user input comprising a selection of one or more portions of the MMM pipeline;
generating, by the processor, a custom MMM pipeline based on the one or more portions;
automatically generating, by the processor, a plurality of MMMs based on the custom MMM pipeline, the custom MMM pipeline using ML applied to the ingested market data, wherein each MMM of the plurality of MMMs models an impact of one or more activities on the performance metric;
ensembling, by the processor, some or all of the plurality of MMMs to determine a unified MMM that models impacts of the one or more activities on the performance metric; and
generating, by the processor, a market mix output based on the unified MMM.

20. The method of claim 19, wherein automatically generating the plurality of MMMs, comprises:
(i) applying, by the processor, ML to some or all of the ingested market data to automatically identify one or more variables that correlate with the performance metric, or (ii) using, by the processor, one or more previous variables previously identified from a prior ML application.
